(19) United States
(12) Patent Application Publication
(10) Pub. No.: US 2010/0220643 A1
(43) Pub. Date: Sep. 2, 2010

(54) Method and Apparatus for Providing Distributed Scheduling

(75) Inventors: Xin Qi, Beijing (CN); Chao Wei, Beijing (CN)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/665,486

(22) PCT Filed: Jun. 17, 2008
(86) PCT No.: PCT/IB2008/001573

§ 371 Date: May 6, 2010

Related U.S. Application Data
(60) Provisional application No. 60/944,595, filed on Jun. 18, 2007.

(51) Int. Cl. H04W 4/00

(52) U.S. Cl. 370/312

(57) ABSTRACT

An approach is provided for distributing scheduling information within a wireless network. A multicast group is configured to include one or more neighboring nodes of a meshed wireless network. A multicast link identifier to each link to the neighboring nodes. Scheduling information is generated for distribution to the multicast group over the corresponding links.

### RELATED APPLICATIONS

This application claims the benefit of the earlier filing date under 35 U.S.C. §119(e) of U.S. Provisional Application Ser. No. 60/944,595 filed Jun. 18, 2007, entitled “Method and Apparatus For Providing Distributed Scheduling,” the entirety of which is incorporated herein by reference.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses, resulting in a high population of subscribers. The telecommunication industry, from manufacturers to service providers, has agreed at great expense and effort to develop standards for communication protocols that underlie the various services and features to ensure interoperability and efficient network operations.

### Some Exemplary Embodiments

Therefore, there is a need for an approach for providing efficient network operations, while being mindful of developing and already developed standards and protocols.

According to one embodiment of the invention, a method comprises configuring a multicast group to include one or more neighboring nodes of a meshed wireless network. The method also comprises assigning a multicast link identifier to each link to the neighboring nodes. Further, the method comprises generating scheduling information for distribution to the multicast group over the corresponding links.

According to another embodiment of the invention, an apparatus comprises logic configured to configure a multicast group to include one or more neighboring nodes of a meshed wireless network, to assign a multicast link identifier to each link to the neighboring nodes, and to generate scheduling information for distribution to the multicast group over the corresponding links.

According to another embodiment of the invention, an apparatus comprises means for configuring a multicast group to include one or more neighboring nodes of a meshed wireless network. The apparatus also comprises means for assigning a multicast link identifier to each link to the neighboring nodes. Further, the apparatus comprises means for generating scheduling information for distribution to the multicast group over the corresponding links.

According to another embodiment of the invention, a system comprises a plurality of nodes arranged as a meshed network, wherein one of the nodes is configured to distribute scheduling information using a multicast protocol to neighboring ones of the nodes, to generate a multicast request message specifying bandwidth requests and slot availability information to the neighboring nodes in the multicast group, and to receive a first grant message, in response to the request message, specifying a set of slots corresponding to the slot availability information. The one node is further configured to track responses from the neighboring nodes designated as requestee nodes, to send a second grant message to indicate a final multicast schedule to the neighboring nodes, and to receive a third grant message from the neighboring nodes confirming the final multicast schedule, the third grant message being further provided to neighboring nodes of the requestee nodes. The one node is further configured to transmit data irrespective of whether the third grant message is received.

According to another embodiment of the invention, a method comprises receiving a multicast scheduling request from a requester node over a meshed wireless network, wherein a multicast group is formed by neighboring nodes of the requester. The method also comprises sending a grant to the requester in response to the request to indicate a selection of transmission opportunities. Further, the method comprises receiving a multicast schedule from the requestor, wherein multicast schedule specifies one or more of the transmission opportunities, and confirming the multicast schedule.

According to yet another embodiment of the invention, an apparatus comprises a first module configured to receive a multicast scheduling request from a requester node over a meshed wireless network, wherein a multicast group is formed by neighboring nodes of the requester. The apparatus also comprises a second module to send a grant to the requester in response to the request to indicate a selection of transmission opportunities. Further, the first module is configured to receive a multicast schedule from the requestor, wherein multicast schedule specifies one or more of the transmission opportunities, and the second module is configured to confirm the multicast schedule.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIGS. 1A and 1B are diagrams of communication systems capable of multicasting scheduling information, according to various embodiments of the invention;

FIGS. 2A and 2B are, respectively, a diagram of an exemplary architecture for multicasting scheduling information, and a flowchart of a process for performing the multicasting scheduling, according to various exemplary embodiments;

FIGS. 3A and 3B are flowcharts of four-way handshake processes for distributing scheduling information, according to various embodiments of the invention;

FIG. 4 is a ladder diagram of a four-way handshake procedure for distributing scheduling information, according to various exemplary embodiments of the invention;

FIGS. 5A and 5B are diagrams of an exemplary WiMAX (Worldwide Interoperability for Microwave Access) architecture, in which the system of FIG. 1A can operate, according to various exemplary embodiments of the invention;

FIGS. 6A-6D are diagrams of communication systems having exemplary long-term evolution (LTE) and E-UTRA (Evolved Universal Terrestrial Radio Access) architectures, in which the system of FIG. 1A can operate to provide resource allocation, according to various exemplary embodiments of the invention;

FIG. 7 is a diagram of hardware that can be used to implement an embodiment of the invention; and

FIG. 8 is a diagram of exemplary components of a user terminal configured to operate in the systems of FIGS. 5 and 6, according to an embodiment of the invention.

### DETAILED DESCRIPTION

An apparatus, method, and software for multicasting scheduling information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless communication network (e.g., compliant with Institute of Electrical & Electronics Engineers (IEEE) 802.16) utilizing multicasting, it is recognized by one of ordinary skill in the art that the embodiments of the inventions have applicability to any type of communication system and equivalent functional capabilities.

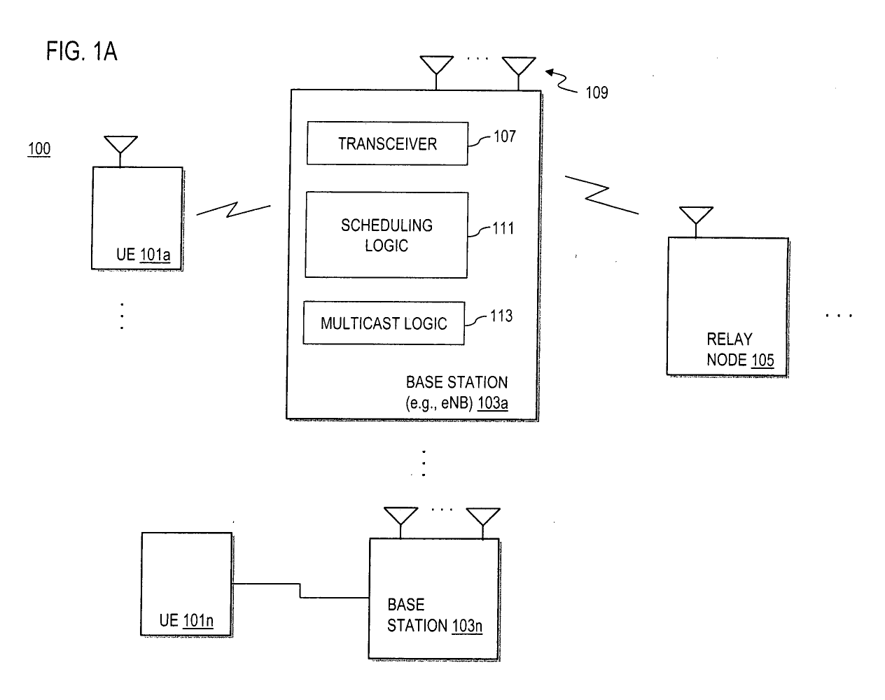

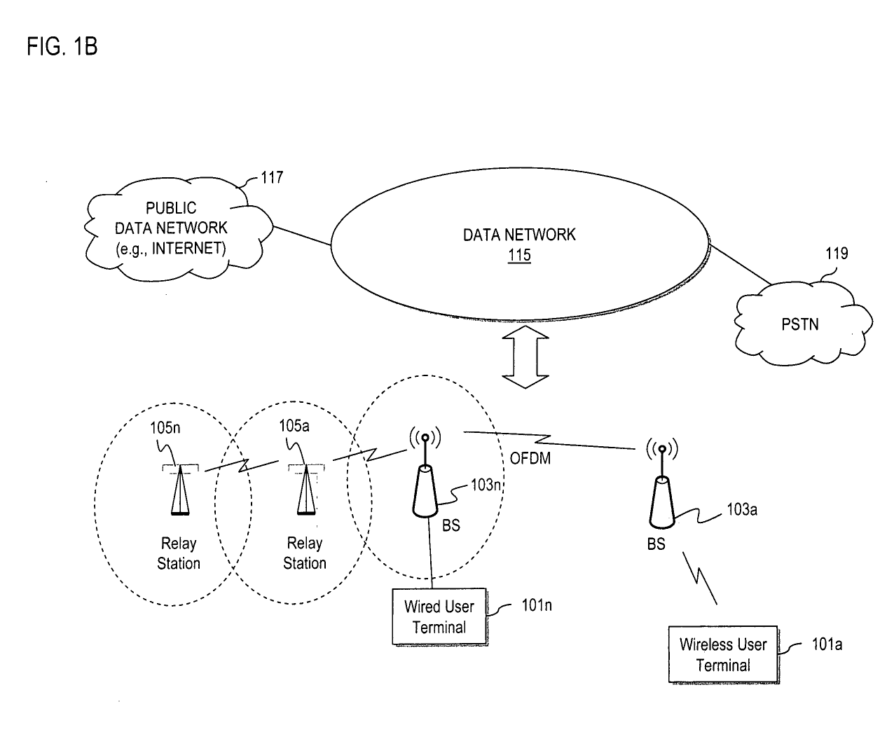

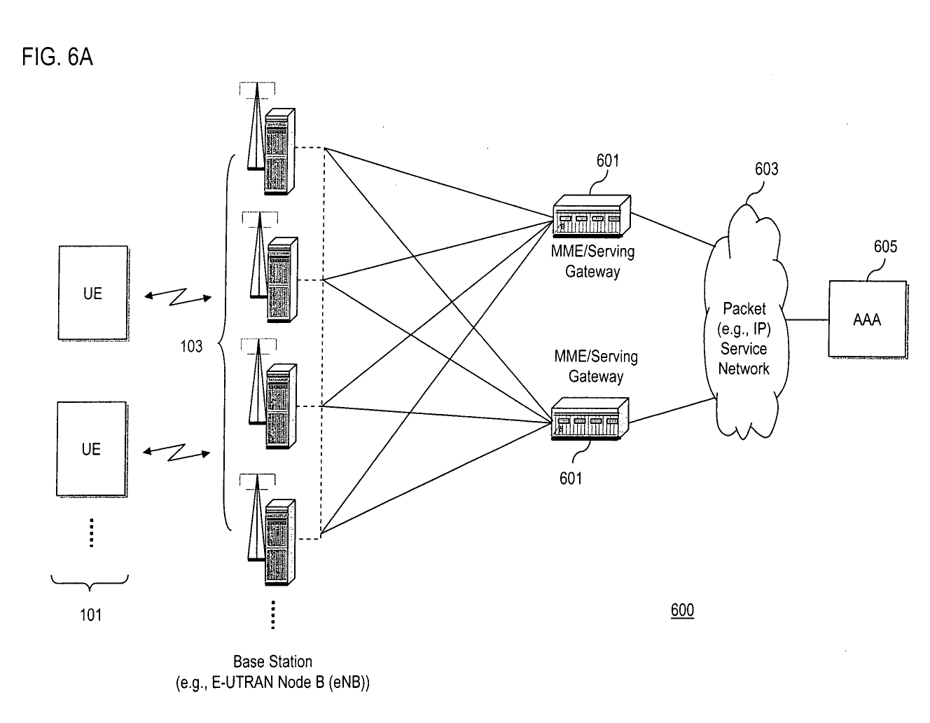

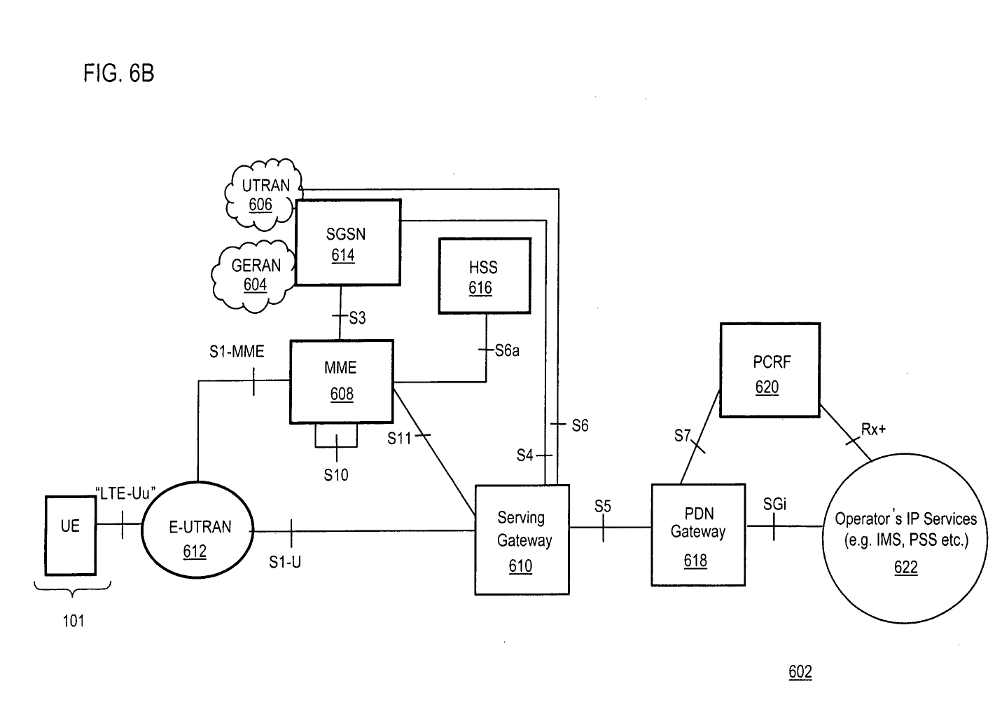

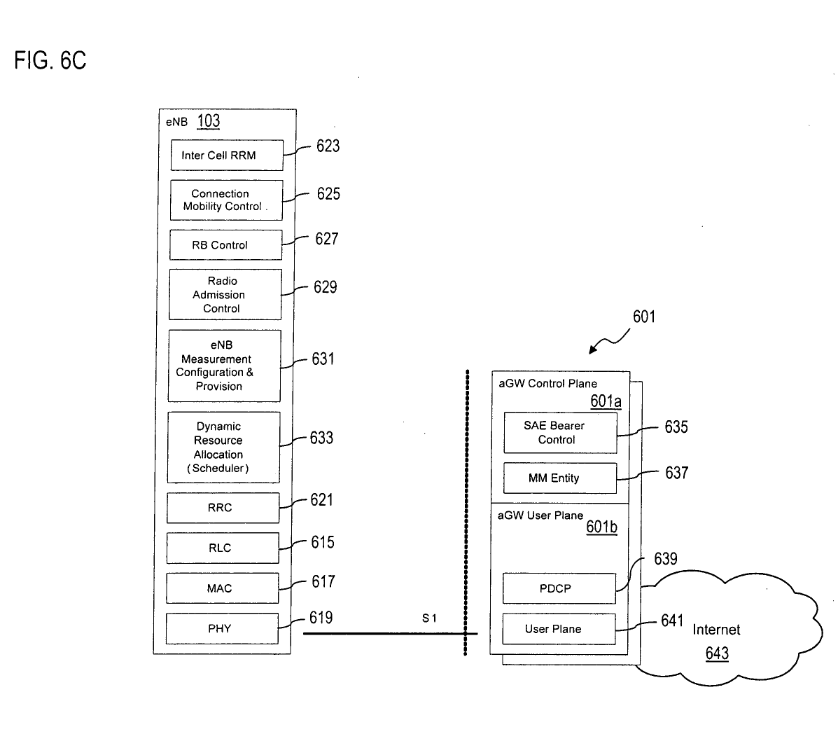

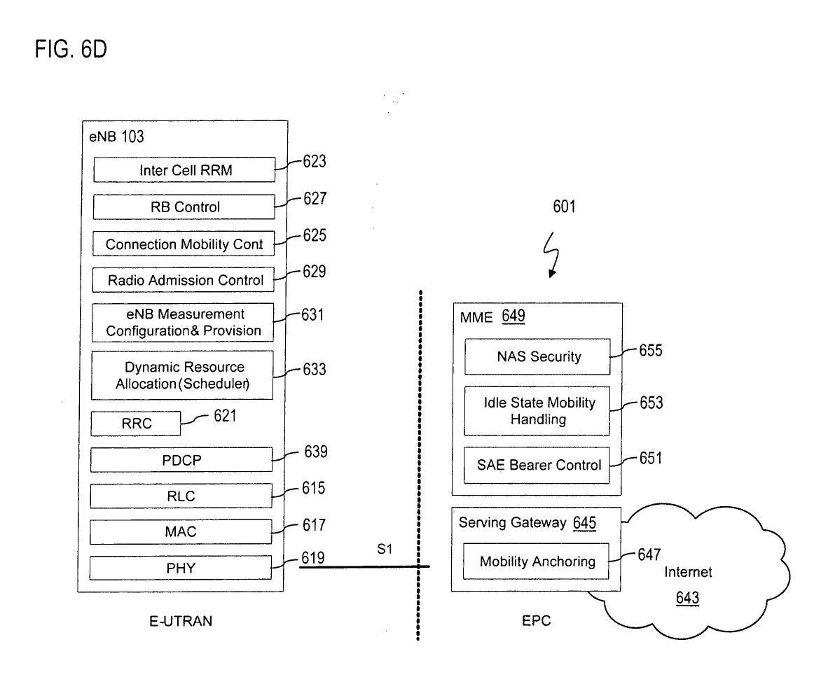

FIGS. 1A and 1B are diagrams of communication systems capable of multicasting scheduling information, according to various embodiments of the invention. As shown in FIG. 1A, one or more user equipment (UEs) 101 communicate with a base station 103, which is part of an access network (e.g., 3GPP LTE (or E-UTRAN), WiMAX, etc.). For example, under the 3GPP LTE architecture (as shown in FIGS. 6A-6D), the base station 103 is denoted as an enhanced Node B (eNB). The UE 101 can be any type of mobile stations, such as handsets, terminals, stations, units, devices, multimedia tablets, Internet nodes, communicators, Personal Digital Assistants or any type of interface to the user (such as “wearable” circuitry, etc.). The UE 101 can communicate with the base station 103 wirelessly, or through a wired connection. For example, UE 101a wirelessly connects to the base station 103a, while the UE 101n can be a wired terminal, which is linked to the base station 103n. The communication system 100 can extend network coverage through the use of one or more relay nodes 105 (one of which is shown).

In the wireless case, the base station 103a employs a transceiver 107, which transmits information to the UE 101a via one or more antennas 109 for transmitting and receiving electromagnetic signals. For instance, the base station 103a may utilize a Multiple Input Multiple Output (MIMO) antenna system 109 for supporting the parallel transmission of independent data streams to achieve high data rates between the UE 101a and base station 103a. The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access) with cyclic prefix for the uplink (UL) transmission scheme. SC-FDMA can also be realized using a DFT-S-OFDM principle, which is detailed in 3GGP TR 25.814, entitled “Physical Layer Aspects for Evolved UTRA,” v.1.5.0, May 2006 (which is incorporated herein by reference in its entirety). SC-FDMA, also referred to as Multi-User-SC-FDMA, allows multiple users to transmit simultaneously on different sub-bands.

Furthermore, the base station 103 includes a scheduling logic 111 and a multicast logic 113 to provide a mechanism creating a contention-free multicast schedule between a source node and a group of target nodes.

For the purposes of illustration, the communication system of FIG. 1B is described with respect to a wireless mesh network (WMN) using WiMAX (Worldwide Interoperability for Microwave Access) technology for fixed and mobile broadband access. WiMAX, similar to that of cellular technology, employs service areas that are divided into cells. As shown, multiple base stations—or base transceiver stations (BTSs) —constitute the radio access network (RAN). WiMAX can operate using Line Of Sight (LOS) as well as near/non LOS (NLOS). The radio access network, which comprises the base stations 103 and relay stations 105, communicates with a data network 115 (e.g., packet switched network), which has connectivity to a public data network 117 (e.g., the global Internet) and a circuit-switched telephony network 119, such as the Public Switched Telephone Network (PSTN).

In an exemplary embodiment, the communication system of FIG. 1B is compliant with IEEE 802.16. The IEEE 802.16 standard provides for fixed wireless broadband Metropolitan Area Networks (MANS), and defines six channel models, from LOS to NLOS, for fixed-wireless systems operating in license-exempt frequencies from 2 GHz to 11 GHz.

In an exemplary embodiment, each of the base stations 103 uses a medium access control layer (MAC) to allocate uplink and downlink bandwidth. As shown, Orthogonal Frequency Division Multiplexing (OFDM) is utilized to communicate from one base station to another base station. For example, IEEE 802.16x defines a MAC (media access control) layer that supports multiple physical layer (PHY) specifications. For instance, IEEE 802.16a specifies three PHY options: an OFDM with 256 sub-carriers; OFDMA, with 2048 sub-carriers; and a single carrier option for addressing multipath problems. Additionally, IEEE 802.16a provides for adaptive modulation. For example, IEEE 802.16j specifies a multihop relay network, which can employ one or more relay stations to extend radio coverage.

The service areas of the RAN can extend, for instance, from 31 to 50 miles (e.g., using 2-11 GHz). The RAN can utilize point-to-multipoint or mesh topologies. Under the mobile standard, users can communicate via handsets within about a 50 mile range. Furthermore, the radio access network can support IEEE 802.11 hotspots.

The communication system of FIG. 1B can, according to one embodiment, provide both frequency and time division duplexing (FDD and TDD). It is contemplated that either duplexing scheme can be utilized. With FDD, two channel pairs (one for transmission and one for reception) are used, while TDD employs a single channel for both transmission and reception.

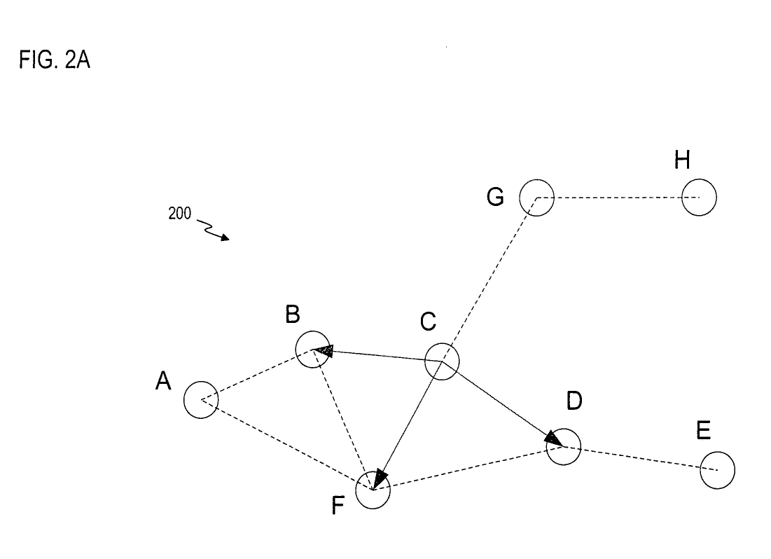

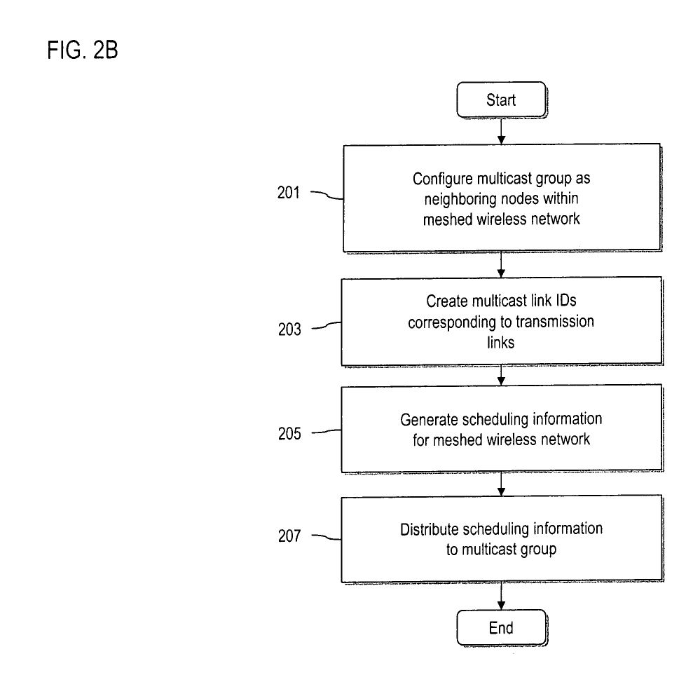

According to one embodiment, the nodes (e.g., BSs 103 and relay stations 105 and UEs 101) can form a mesh network, as explained in the architecture of FIG. 2A.

FIGS. 2A and 2B are, respectively, a diagram of an exemplary architecture for multicasting scheduling information, and a flowchart of a process for performing the multicasting scheduling, according to various exemplary embodiments. System 200 of FIG. 2A, according to an exemplary embodiment, is a wireless mesh network (WMN) that multicast data packets when using distributed scheduling, such as the IEEE 802.16 (which is more fully described in IEEE Standard for Local and Metropolitan Area Networks Part 16: Air Interface for Fixed Broadband Wireless Access Systems, October 2004; which is incorporated herein by reference in its entirety). According to certain embodiments, the “multicast” mechanism is performed at the Medium Access Control (MAC) layer. In this manner, the packets from a node in the WMN are multicasted to a subset of its neighborhood (i.e., not broadcasted to all the neighbors or unicasted to one of them). The neighborhood of a node denotes all the nodes one-hop away from it, for example.

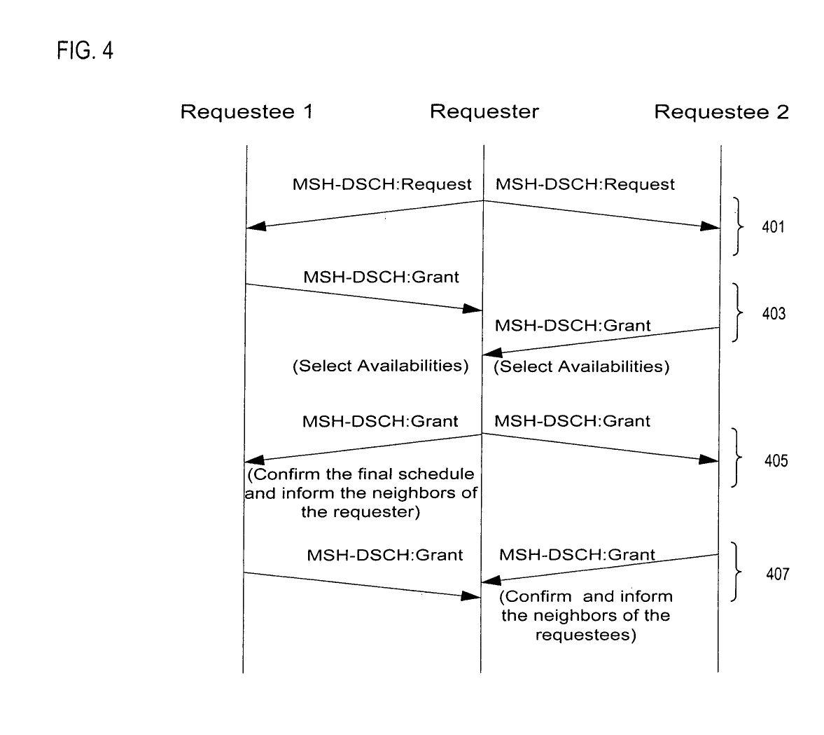

According to one embodiment, a four-way handshake procedure (as shown in FIG. 4) is explained for creating the contention-free multicast schedule between the source node and a group of target nodes. Also, another procedure is provided to create/release the multicast group link identifier (ID) of target nodes. It is noted that the handshake procedure can also support contention-free broadcast scheduling of data packets transmission. Using these procedures, scheduling and addressing of multicast links can be implemented in 802.16 distributed scheduling WMNs, so that multicast transmission can be performed. According to various embodiments, time division multiple access (TDMA) is employed as the access method for the WMN.

Traditionally, in the distributed scheduling of typical WMNs (e.g., IEEE 802.16 mesh mode), two directional physical links exist between every pair of neighboring nodes. Each directional physical link has a link ID, which is assigned by the transmitting node when the link is created between the transmitting node and the receiving node. The transmitting node uses the link ID to address the receiving node. The receiving node knows from the link ID and the transmitting Node ID of a received packet whether this packet targets for itself. Data packet transmission is scheduled over a physical link between a transmitting node and a receiving node, i.e., in a unicast way. Broadcast is used when controlling messages are transmitted. Thus, in traditional protocols of these WMNs, MAC-layer multicast is not supported, because there is neither a scheduling procedure for multicast transmission, nor a multicast addressing method.

Two examples are given below to illustrate the potential drawbacks of conventional systems. In the first scenario, group data dissemination is examined. In FIG. 2A, the circles represent mesh nodes (e.g., base stations or user terminals) and dashed lines denote physical links between two nodes. In this example, nodes A-H belong to a single WMN and uses distributed scheduling. Although the nodes can represent base stations or user terminals, there is no need to differentiate between mesh base stations and mesh user nodes in this scenario.

It is assumed that Node C has the same data packets to send to the group of nodes B, D, F. Traditionally, without MAC-layer multicast, the same packets can be scheduled serially over the links (C, B), (C, F) and (C, D). Because the same data are transmitted three times, network resources are wasted. On the other hand, if Node C schedules a broadcast transmission for the packets, then Node G cannot use the very opportunity to transmit data to Node H; although the following is noted: 1) Node G need not receive the broadcast packets; 2) Node H is not interfered by the broadcast; and 3) Nodes B/F/D are not interfered by the transmission of Node G. In this case, though transmitting energy would be saved, bandwidths of uncorrelated links tend to be lost. However, if a multicast transmission could be scheduled in this scenario, energy and bandwidth will be saved simultaneously. These savings are particularly prominent with in low-speed real-time applications, such as real-time gaming.

As a second example, when low-speed real-time traffic are transmitted from a node to multiple other nodes in an 802.16/rooftop mesh network and distributed scheduling is used, the transmission efficiency is poor because of the overhead (e.g., the PHY (physical layer) preamble) added to the data packets. By way of illustration, Voice over IP (VoIP) traffic is transported over the network; i.e., VoIP traffic from Node C to Nodes B, D and F simultaneously. For example, if Global System for Mobile Communications (GSM) 6.10 is chosen for the voice codec, there is a 33-byte voice packet every 20 ms for every VoIP link. Under the conventional system, such traffic is scheduled over the three links separately. For every link, the overhead of a mesh MAC PDU (Protocol Data Unit) is 12 bytes, including a 6-byte MAC header, a 2-byte mesh subheader and an optional 4-byte CRC (Cyclic Redundancy Check). The IP/UDP/RTP (Internet Protocol/User Datagram Protocol/Real-time Transport Protocol) header is 40-byte long. Thus, the PHY payload of a VoIP packet is about 85 bytes, which typically needs 2 Orthogonal Frequency Division Modulation (OFDM) symbols. Otherwise, every PHY burst in 802.16 mesh mode has a preamble of 2 OFDM symbols. Therefore, to transmit all the three VoIP traffic, at least (2+2)*3=12 OFDM symbols are needed every 20 ms—this is not efficient.

However, it is recognized that if the small packets could be multiplexed into a single PHY burst and multicast to the target node group, according to an exemplary embodiment, the transmission efficiency can be much improved. Under this approach, only one preamble and one MAC overhead is needed. Therefore, every 20 ms at most 2*3+2=8 OFDM symbols are needed to transmit the packets. In certain scenarios, the three IP/UDP/RTP headers can be replaced with three 2-byte mini-headers plus one IP/UDP header of 28 bytes. In this case, the overall PHY overhead is (33+2)*3+28+12=145 bytes, which is typically about 3 to 4 OFDM symbols. Consequently, inclusive of the preamble, at most 6 symbols are needed.

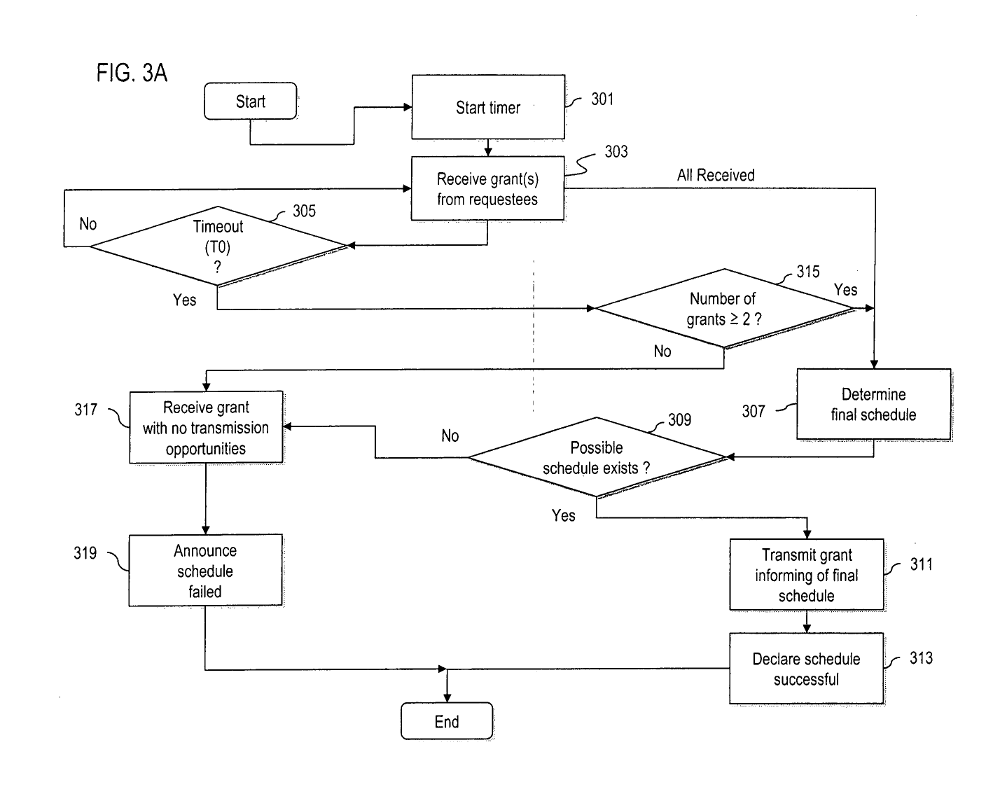

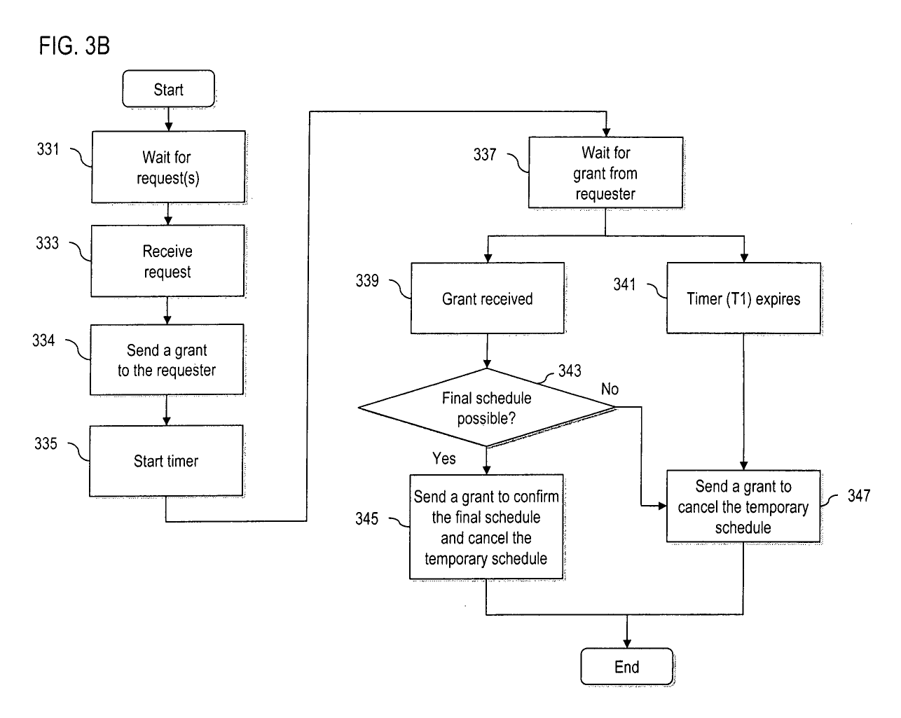

In FIG. 2B, a process is provided for distributing scheduling information to address the above drawbacks. In step 201, a multicast group is configured as a group of neighboring nodes within the meshed network 200. Next, the process creates identifiers for the multicast transmission links, as in step 203. Scheduling information is then generated for the network 200, per step 205. Thereafter, the generated scheduling information is distributed, as in step 207, to the multicast group. This process is further detailed in FIGS. 3A and 3B.

FIGS. 3A and 3B are flowcharts of four-way handshake processes for distributing scheduling information, according to various embodiments of the invention. These processes define a procedure for creating, in an exemplary embodiment, a MAC-layer multicast schedule between the source node and a group of target nodes, as well as another procedure to create/release the multicast group link ID of target nodes. Under this approach, scheduling and addressing of multicast links can be implemented in 802.16 distributed scheduling WMNs, so that multicast transmission can be performed.

The four-way handshake scheduling procedure, as shown in FIGS. 3A and 3B, provides for distributed scheduling using multicasting among the nodes in the system 200 of FIG. 2 (which can be a 802.16 WMN). In one embodiment, a multicast scheduling request message (MSH-DSCH:Request) is made by the source node (requester) and broadcasted to his neighborhood. The message includes bandwidth requests to all the nodes (requestees) in the target group of the multicast, as well as all the possible slots (availabilities) of the source node for the schedule.

A grant message (MSH-DSCH:Grant) is sent back to the requester from every requestee to indicate a set of all the slots that could be used by the requestee in the suggested availabilities. Because a requestee cannot know the selection of transmission opportunities by other requestees, it selects a maximum possible number of transmission opportunities from the suggested ones from the requester, so that the requester can decide the final schedule using the intersection of the requestees' selections. Thus, the schedule granted in this message is only a temporary schedule (reservation). The neighbors of the requestees not involved in this multicast schedule can assume the transmissions take place as granted by the temporary schedule.

In FIG. 3A, a start timer (denoted T0) is initiated for receiving grants (steps 301 and 303). After the requester receives the grants from all the requestees or a specific timer expires (as determined in step 305), it sends another grant message to inform the final multicast schedule to all the requestees who are eligible for this time of the multicast schedule. The final schedule is an intersection of the selections from all the requestees that sent back the grant message. In step 307, the final schedule is determined by as the received grants. The schedule is decided, for example, by the source node so that a maximum number of the target nodes can be included in the multicast transmission. In step 309, the process determines whether the schedule exists; if so, the grants are transmitted to inform the group of such a schedule (step 311). The neighbors of the requester not involved in this multicast schedule assumes the transmissions take place as granted. The requester multicasts the data packets based on the grant, regardless of whether it has received the grant messages from the requestees or not. In step 313, the dissemination of the schedule is declared successful.

In step 315, the process determines whether two or more grants have been received. If multiple grants have been received, then the above steps 307-313 can be performed. Otherwise, as in step 317, a grant (with zero transmission opportunities specified) can indicate the failure of the schedule. Namely, if there are no possible transmission opportunities that can be found for the multicast, then a schedule with zero transmission opportunity will be sent to the requestees in the grant message to announce the failure of the multicast schedule (step 319).

FIG. 3B illustrates four-way handshake process at the requestee. In step 331, the process waits for a request (e.g., MSH-DSCH); and upon receipt of the request (step 333), a grant message (MSH-DSCH:Grant) is sent back to the requester (step 334) and a timer (denoted T1) is started, per step 335. At this point, the process involves waiting for the grant of final schedule from the requester, as in step 337. As seen, the steps 339 and 341 of receiving the grant and the expiration of the timer, T1, respectively are independent, and thus, occur concurrently.

Each requestee checks the grant message from the requester. In step 343, it is determined whether the final schedule is possible. If the granted slots are available to the requestee, the requestee will send for the second time a grant message, as in step 345, to the requester to confirm the final schedule, and to inform all its neighbors that the temporary schedule granted is cancelled (step 347). The neighbors of the requestees not involved in this multicast schedule assume the transmissions are provided as granted by the new schedule. If the slots granted by the requester are not available to the requestee, the requestee knows that it is now excluded from the multicast link and can still send a grant message to cancel the temporary schedule that was previously granted.

It is noted that there are some exceptional circumstances in which the grant from the requester cannot reach a requestee. In this case, the requestee can automatically quit from the multicast schedule after timeout and send a grant message to cancel the temporary schedule that was granted.

As shown in FIGS. 3A and 3B, T0 and T1 represent timers at the requester and requestees. The computation of the expiration time of T0 and T1 can be implemented in any number of ways. For example, they can be fixed parameters, or be assigned as system parameters since the creation of the WMN, or be assigned by the requester and transmitted to the requestees using the multicast scheduling request message. It is contemplated that this multicast scheduling procedure can also support contention-free broadcast scheduling of data packets transmission. The four-way procedure may result in a relatively longer delay before start of the data transmission than a three-way procedure for the unicast transmission. This delay can be mitigated, as next explained.

FIG. 4 is a ladder diagram of a four-way handshake procedure for distributing scheduling information, according to various exemplary embodiments of the invention. An example on a successful four-way handshake is depicted in FIG. 4; in this example, the multicast scheduling is conducted between one requester and two requestees. In step 401, the requester sends a bandwidth request message to the two requestees. Next, the two requestees select a set of possible transmission opportunities and send temporary bandwidth grants message to the requester before the requester's T0 timeout, per step 403.

Next, the requester successfully receives the temporary bandwidth grants and decides a feasible schedule. The request then broadcasts to its neighbors a grant message including the multicast schedule information, as in step 405. Subsequently, the two requestees successfully receive the grant message. Each one broadcasts, as in step 407, a grant message to confirm the final multicast schedule to the requester and to inform all its neighbors to release the temporary schedule. The above steps 401-407 constitute the four-way handshake.

Every multicast transmission is identified by a multicast link ID. The link ID can be created before or during the four-way handshake. After all the scheduled transmissions finish, the source node can choose to release the link ID or not. The procedure to create/release the multicast group link ID of target nodes is as follows. To create the multicast link ID, a request for every requestee to create the new multicast link ID is transmitted in a MSH-DSCH message from the requester. Thereafter, a grant to confirm the creation is sent back to the requester in a MSH-DSCH message from every requestee.

To release the multicast link ID, a request for every requestee to release the new multicast link ID is transmitted in a MSH-DSCH message from the requester. A grant to confirm the release is sent back to the requester in a MSH-DSCH message from every requestee.

If the multicast link ID does not exist before the multicast scheduling handshake, the multicast link ID creation can be performed using the same messages as those in the first two steps of the four-way handshake procedure. When the multicast link ID is created, two (directional) link IDs between the source and every target node involved in the multicast are provided. The first one is the formerly assigned unicast link ID when creating the unicast link between the two nodes. The second one is the multicast link ID for the multicast transmission, which is a common link ID to all of the target nodes.

In a three-way handshake (as employed in the 802.16/rooftop WMN distributed scheduling), several messages have been defined that can be used and/or modified for the four-way handshake procedure. That is, it is possible to introduce multicast transmission by modifying the messages so that the procedures defined here are supported. For example, modifications are made to the mesh distributed scheduling message (MSH-DSCH) of 802.16 mesh mode.

According to one embodiment, the entries of the modified MSH-DSCH message (over the conventional format) are shown in Table 1 (in bold text). The entries of the original MSH-DSCH message are mainly preserved, except that the reserved bits are modified to be two flags, whose meaning are explained Table 1. Therefore, when the two flags are all set to be zero, i.e., no special multicast function is included, the message resembles the original version. By way of example, it is assumed that the expiration times of T0 and T1 (in FIGS. 3A and 3B) are fixed parameters speculated by the protocol.

TABLE 1

| Syntax | Size | Notes |
|---|---|---|
| MSH-DSCH_Message_Format( ){ | | |
| Management Message Type =41 | 8 bits | |
| Coordination Flag | 1 bits | |
| Grant/Request Flag | 1 bits | |
| Sequence counter | 6 bits | |
| No. Requests | 4 bits | |
| No. Availabilities | 4 bits | |
| No. Grants | 6 bits | |
| MCA Link Flag | 1 bits | 0 = no multicast create/release in this message, i.e. no |
| | | DSCH_MCA_link_IE is included in the message |
| | | 1 = multicast create/release exists, i.e. |
| | | DSCH_MCA_link_IE is included in the message |
| MCA Tmp Grant Flag | 1 bits | 0 = no DSCH_MCA_Tmp_Grant_IE is included in the |
| | | message |
| | | 1 = DSCH_MCA_Tmp_Grant_IEs are included in the |
| | | message, only possible for the second step of the four- |
| | | way handshake |
| [symbol] | | Removed from the original message. |
| if (Coordination Flag == 0) | | |
| MSH-DSCH_Scheduling_IE( ) | variable | |
| for (i=0; i< No_Requests; ++i) | | |
| MSH-DSCH_Request_IE( ) | 16 bits | |
| for (i=0; i< No_Availabilities; ++i) | | |
| MSH-DSCH_Availability_IE( ) | 32 bits | |
| for (i=0; i< No_Grants; ++i) | | |
| MSH-DSCH_Grant_IE( ) | 40 bits | |
| If (MCA Link Flag){ | | |
| No. MCA link | 4 bits | The number of the multicast links to be |
| | | created/released by this message |
| for (i=0; i< No. MCA link; ++i) | | |
| MSH-DSCH_MCA_link_IE( ) | variable | |
| } | | |
| If (MCA Tmp Grant Flag){ | | |
| No. MCA Tmp Grant | 4 bits | The number of the second-step multicast grants |
| | | included in this message |
| for (i=0; i< No. MCA Tmp Grant; | | |
| ++i) | | |
| MSH- | variable | |
| DSCH_MCA_Tmp_Grant_IE( ) | | |
| } | | |
| } | | |

The bandwidth request/grant information elements (IEs) are of the same format for the cases of both multicast and original unicast transmission, except for the temporary schedule grant IE for the second step (step 403) of the procedure.

When the request/grant is related to a multicast transmission, the link ID of the multicast is used in the IE by the requester. After a node receives a bandwidth request to it, it judges from the link ID that whether this request is for a multicast transmission. If it is and only for this case, the requestee transmits MSH-DSCH Multicast Temporary Grant IE in the next MSH-DSCH message to grant the transmission, as the second step (step 403) of the four-way handshake. In the third and fourth steps (steps 405 and 407) of the procedure, the MSH-DSCH Grant IE will be used. The entries of the MSH-DSCH Multicast Temporary Grant IE are shown in Table 2.

TABLE 2

| Syntax | Size | Notes |
|---|---|---|
| MSH-DSCH_MCA_Tmp_Grant_IE( ){ | | |
| link ID | 8 bits | The link ID assigned by the transmitting node |
| | | (requestee of the multicast) to neighbor (the |
| | | requester) that this grant involves. |
| No. Tmp Grant | 4 bits | The number of granted transmission opportunities |
| | | selected from the suggested availabilities. Because |
| | | this is not the final schedule and the requester will |
| | | decide the schedule based on this grants from all the |
| | | requestees, the requestee can select as many |
| | | transmission opportunities as it could from the |
| | | suggested availabilities, possibly much larger than |
| | | the bandwidth requested by the requester. |
| for (i=0; i< No. Tmp Grant; ++i){ | | |
| Start Frame number | 8 bits | Schedule start: Indicates lowest 8 bits of frame |
| | | number in which the schedule is granted. |
| Minislot start | 8 bits | The start position of the reservation within a frame. |
| Minislot range | 8 bits | The number of minislots reserved. |
| } | | |
| Persistence | 3 bit | Persistency field for grants. Number of frames over |
| | | which the grant is allocated. |
| | | 0 = cancel reservation; 1 = single frame; 2 = |
| | | 2 frames; |
| | | 3 = 4 frames; 4 = 8 frames; 5 = 32 frames; |
| | | 6 = 128 frames |
| | | 7 = Good until cancelled or reduced |
| Channel | 4 bits | Logical channel number |
| Reserve | 1 bit | Set to zero |
| } | | |

The multicast link ID is created and released using the MSH-DSCH Multicast link IE, the entries of which are shown in Table 3.

The multicast link ID can be created before or simultaneously with the multicast bandwidth scheduling handshake. For the link ID creation process before the scheduling, the source node sends a Multicast link request IE in a MSH-DSCH message with the grant/request flag being set to 1 and the creation/release flag being 0. If the receiving node receives the message and accepts this creation, the receiving node sends back a Multicast link grant IE with the flags set according to Table 3. Otherwise, the node sends nothing.

For the link ID creation process (performed, e.g., simultaneously, with the scheduling handshake), in the bandwidth request of a multicast transmission, a multicast link creation request IE is involved in the MSH-DSCH:Request message from the requester. The multicast link ID in the link creation request IE is the same with the one in the bandwidth request IE. In this case, the requestees add themselves to link denoted by the multicast link ID immediately and make the MSH-DSCH:Grant messages to grant the bandwidth request. Multicast link creation grant IEs is involved in the same MSH-DSCH:Grant messages from the requestees in the second step (step 403) of the procedure.

The multicast link ID is released also by the multicast link IE with the flags set according to Table 3, which can be performed whenever the source node wants to, after or before the finish of the multicast transmission as scheduled. If the source node uses the IE to inform the target nodes that the multicast link ID should be released before the transmission finishes as scheduled, thereby terminating the multicast transmission. The requestees can grant the release using the Multicast link IE in a MSH-DSCH message thereafter and release the remaining reserved transmission opportunities. It is also contemplated that after the multicast transmission finishes per the schedule, the source node does not release the multicast link ID, which will be left available for future usage.

TABLE 3

| Syntax | Size | Notes |
|---|---|---|
| MSH-DSCH_MCA_link_IE( ){ | | |
| MCA grant/request flag | 1 bit | 0 = grant for the creation/release of the multicast link |
| | | ID |
| | | 1 = request for the creation/release of the multicast link |
| | | ID |
| MCA create/release flag | 1 bit | 0 = creation of the multicast link ID |
| | | 1 = release of the multicast link ID |
| If (MCA grant/request flag){ | | |
| No. MCA Target | 6 bits | Number of the receiving nodes in the target group of |
| | | the multicast transmission |
| for (i=0; i< No. MCA Target; | | |
| ++i) | | |
| Link ID | 8 bits | The unicast link ID assigned by the transmitting node |
| | | (requester), pointed to one receiving node (requestee) |
| | | in the target group of the multicast transmission. |
| | | Every target node is related to a certain unicast link ID |
| | | formerly assigned by the source node. |
| } | | |
| else | | |
| Link ID | 8 bits | The link ID assigned by the transmitting node |
| | | (requestee of the multicast) to the neighbor (the |
| | | requester of the multicast) that this grant involves. |
| MCA link ID | 8 bits | The multicast link ID for creation/release. |
| } | | |

Two kinds of distributed scheduling are defined in the 802.16 mesh mode: coordinated and uncoordinated. In the uncoordinated distributed scheduling, the scheduling messages are transmitted in a contention-based way. Accordingly, in an exemplary embodiment, multicast scheduling can also be contention-based. For the coordinated scheduling, the protocol speculates that the MSH-DSCH is to be sent in a coordinated way, namely in the collision-free scheduling control subframe based on the pseudo-random distributed election algorithm.

As mentioned, delay can be relatively longer under the four-way multicast scheduling approach, as opposed to three-way unicast scheduling. Consequently, the following approach is explained to minimize this delay. The temporary grants in second step (step 403) of the handshake and the final grants in the fourth step (step 407) are still transmitted in the control subframe. The grant message of the third step (step 405) is transmitted in the scheduled transmission opportunities in the data subframe, which have already been reserved temporarily by the grants in the second step. As earlier mentioned, the requester multicasts the data after the third step, regardless of whether it has already received the grants of the fourth step. In this way, the delay of the whole procedure can be significantly reduced (e.g., not longer than the three-way procedure for unicast), while the grant messages can be transmitted in a contention-free manner.

The above approach can also support a multiplex-multicast method for low-speed real-time traffic. It is noted that the bandwidth requested by the requester may be larger than what is finally granted, because the bandwidth for this kind of multicast is related to the number of the requestees. The requester requests for the bandwidth reservation that could contain the data for all the requestees. However, some requestees may not be able to join the multicast. In this case, the data to be multicasted will be less than requested. The requester will compute the final bandwidth reservation based on the maximum number of requestees that can receive the data.

The described processes provide, according to certain embodiments, MAC-layer multicast in the 802.16/rooftop distributed scheduled WMN. This approach advantageously can improve power and bandwidth efficiency when group transmission and low-speed real-time applications are transmitted over it.

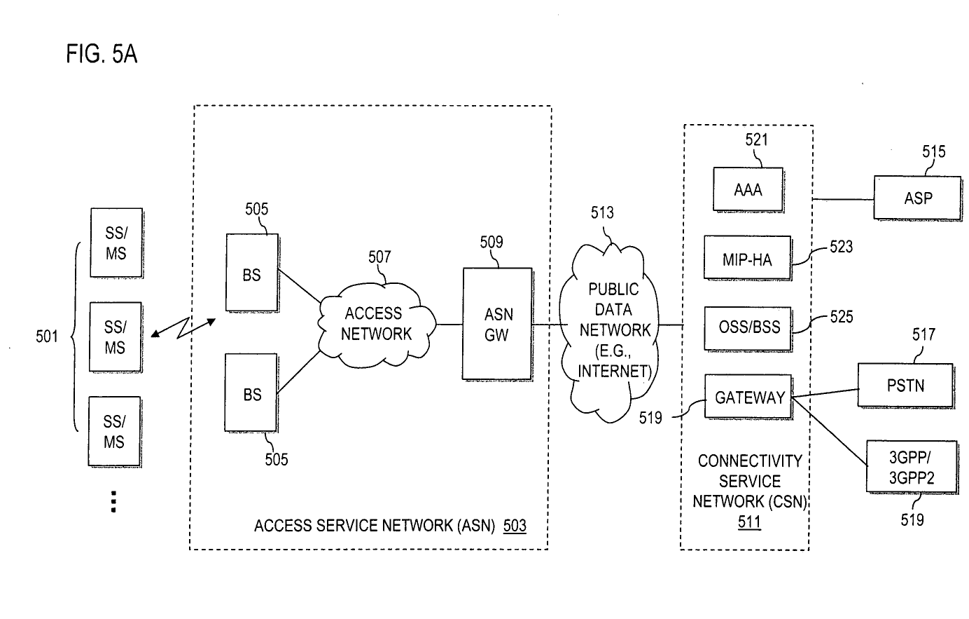

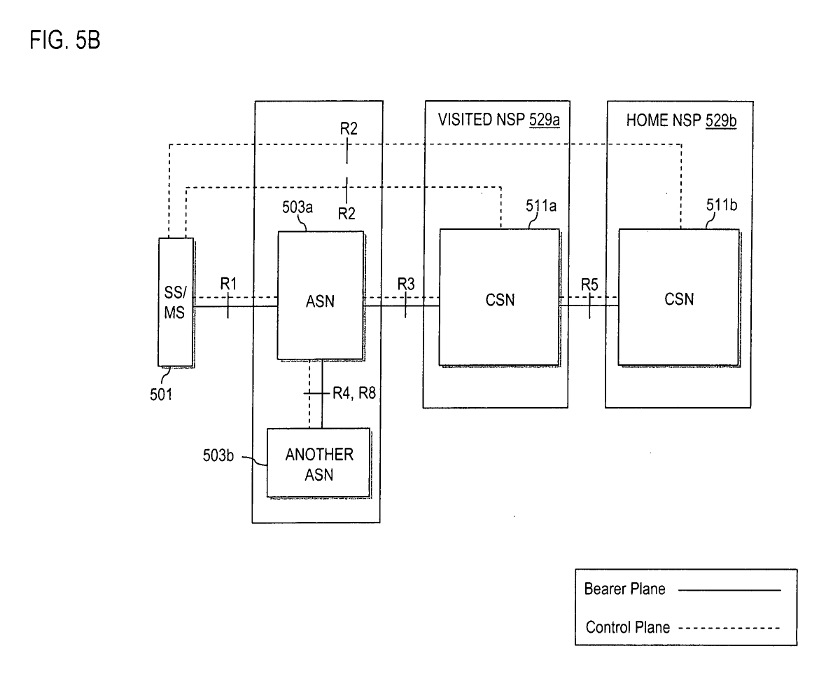

FIGS. 5A and 5B are diagrams of an exemplary WiMAX architecture, in which the system of FIG. 1A, according to various exemplary embodiments of the invention. The architecture shown in FIGS. 5A and 5B can support fixed, nomadic, and mobile deployments and be based on an Internet Protocol (IP) service model.

Subscriber or mobile stations 501 can communicate with an access service network (ASN) 503, which includes one or more base stations (BS) 505. In this exemplary system, the BS 505, in addition to providing the air interface to the mobile stations 501, possesses such management functions as handoff triggering and tunnel establishment, radio resource management, quality of service (QoS) policy enforcement, traffic classification, DHCP (Dynamic Host Control Protocol) proxy, key management, session management, and multicast group management.

The base station 505 has connectivity to an access network 507. The access network 507 utilizes an ASN gateway 509 to access a connectivity service network (CSN) 511 over, for example, a data network 513. By way of example, the network 513 can be a public data network, such as the global Internet.

The ASN gateway 509 provides a Layer 2 traffic aggregation point within the ASN 503. The ASN gateway 509 can additionally provide intra-ASN location management and paging, radio resource management and admission control, caching of subscriber profiles and encryption keys, AAA client functionality, establishment and management of mobility tunnel with base stations, QoS and policy enforcement, foreign agent functionality for mobile IP, and routing to the selected CSN 511.

The CSN 511 interfaces with various systems, such as application service provider (ASP) 515, a public switched telephone network (PSTN) 517, and a Third Generation Partnership Project (3GPP)/3GPP2 system 519, and enterprise networks (not shown).

The CSN 511 can include the following components: Access, Authorization and Accounting system (AAA) 521, a mobile IP-Home Agent (MIP-HA) 523, an operation support system (OSS)/business support system (BSS) 525, and a gateway 527. The AAA system 521, which can be implemented as one or more servers, provide support authentication for the devices, users, and specific services. The CSN 511 also provides per user policy management of QoS and security, as well as IP address management, support for roaming between different network service providers (NSPs), location management among ASNs.

FIG. 5B shows a reference architecture that defines interfaces (i.e., reference points) between functional entities capable of supporting various embodiments of the invention. The WiMAX network reference model defines reference points: R1, R2, R3, R4, and R5. R1 is defined between the SS/MS 501 and the ASN 503a; this interface, in addition to the air interface, includes protocols in the management plane. R2 is provided between the SS/MS 501 and a CSN (e.g., CSN 511a and 511b) for authentication, service authorization, IP configuration, and mobility management. The ASN 503a and CSN 511a communicate over R3, which supports policy enforcement and mobility management.

R4 is defined between ASNs 503a and 503b to support inter-ASN mobility. R5 is defined to support roaming across multiple NSPs (e.g., visited NSP 529a and home NSP 529b).

As mentioned, other wireless systems can be utilized, such as 3GPP LTE, as next explained.

FIGS. 6A-6D are diagrams of communication systems having exemplary long-term evolution (LTE) architectures, in which the user equipment (UE) and the base station of FIG. 1 can operate, according to various exemplary embodiments of the invention. By way of example (shown in FIG. 6A), a base station (e.g., destination node) and a user equipment (UE) (e.g., source node) can communicate in system 600 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-FDMA, while downlink utilizes OFDMA.

The communication system 600 is compliant with 3GPP LTE, entitled “Long Term Evolution of the 3GPP Radio Technology” (which is incorporated herein by reference in its entirety). As shown in FIG. 6A, one or more user equipment (UEs) communicate with a network equipment, such as a base station 103, which is part of an access network (e.g., WiMAX (Worldwide Interoperability for Microwave Access), 3GPP LTE (or E-UTRAN), etc.). Under the 3GPP LTE architecture, base station 103 is denoted as an enhanced Node B (eNB).

MME (Mobile Management Entity)/Serving Gateways 601 are connected to the eNBs 103 in a full or partial mesh configuration using tunneling over a packet transport network (e.g., Internet Protocol (IP) network) 603. Exemplary functions of the MME/Serving GW 601 include distribution of paging messages to the eNBs 103, termination of U-plane packets for paging reasons, and switching of U-plane for support of UE mobility. Since the GWs 601 serve as a gateway to external networks, e.g., the Internet or private networks 603, the GWs 601 include an Access, Authorization and Accounting system (AAA) 605 to securely determine the identity and privileges of a user and to track each user's activities. Namely, the MME Serving Gateway 601 is the key control-node for the LTE access-network and is responsible for idle mode UE tracking and paging procedure including retransmissions. Also, the MME 601 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 6B, a communication system 602 supports GERAN (GSM/EDGE radio access) 604, and UTRAN 606 based access networks, E-UTRAN 612 and non-3GPP (not shown) based access networks, and is more fully described in TR 23.882, which is incorporated herein by reference in its entirety. A key feature of this system is the separation of the network entity that performs control-plane functionality (MME 608) from the network entity that performs bearer-plane functionality (Serving Gateway 610) with a well defined open interface between them S11. Since E-UTRAN 612 provides higher bandwidths to enable new services as well as to improve existing ones, separation of MME 608 from Serving Gateway 610 implies that Serving Gateway 610 can be based on a platform optimized for signaling transactions. This scheme enables selection of more cost-effective platforms for, as well as independent scaling of, each of these two elements. Service providers can also select optimized topological locations of Serving Gateways 610 within the network independent of the locations of MMEs 608 in order to reduce optimized bandwidth latencies and avoid concentrated points of failure.

As seen in FIG. 6B, the E-UTRAN (e.g., eNB) 612 interfaces with UE 101 via LTE-Uu. The E-UTRAN 612 supports LTE air interface and includes functions for radio resource control (RRC) functionality corresponding to the control plane MME 608. The E-UTRAN 612 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 608, as a key control node, is responsible for managing mobility UE identifies and security parameters and paging procedure including retransmissions. The MME 608 is involved in the bearer activation/deactivation process and is also responsible for choosing Serving Gateway 610 for the UE 101. MME 608 functions include Non Access Stratum (NAS) signaling and related security. MME 608 checks the authorization of the UE 101 to camp on the service provider's Public Land Mobile Network (PLMN) and enforces UE 101 roaming restrictions. The MME 608 also provides the control plane function for mobility between LTE and 2G/3G access networks with the S3 interface terminating at the MME 608 from the SGSN (Serving GPRS Support Node) 614.

The SGSN 614 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 608 and HSS (Home Subscriber Server) 616. The S10 interface between MMEs 608 provides MME relocation and MME 608 to MME 608 information transfer. The Serving Gateway 610 is the node that terminates the interface towards the E-UTRAN 612 via S1-U.

The S1-U interface provides a per bearer user plane tunneling between the E-UTRAN 612 and Serving Gateway 610. It contains support for path switching during handover between eNBs 103. The S4 interface provides the user plane with related control and mobility support between SGSN 614 and the 3GPP Anchor function of Serving Gateway 610.

The S12 is an interface between UTRAN 606 and Serving Gateway 610. Packet Data Network (PDN) Gateway 618 provides connectivity to the UE 101 to external packet data networks by being the point of exit and entry of traffic for the UE 101. The PDN Gateway 618 performs policy enforcement, packet filtering for each user, charging support, lawful interception and packet screening. Another role of the PDN Gateway 618 is to act as the anchor for mobility between 3GPP and non-3GPP technologies such as WiMax and 3GPP2 (CDMA 1X and EvDO (Evolution Data Only)).

The S7 interface provides transfer of QoS policy and charging rules from PCRF (Policy and Charging Role Function) 620 to Policy and Charging Enforcement Function (PCEF) in the PDN Gateway 618. The SGi interface is the interface between the PDN Gateway and the operator's IP services including packet data network 622. Packet data network 622 may be an operator external public or private packet data network or an intra operator packet data network, e.g., for provision of IMS (IP Multimedia Subsystem) services. Rx+ is the interface between the PCRF and the packet data network 622.

As seen in FIG. 6C, the eNB 103 utilizes an E-UTRA (Evolved Universal Terrestrial Radio Access) (user plane, e.g., RLC (Radio Link Control) 615, MAC (Media Access Control) 617, and PHY (Physical) 619, as well as a control plane (e.g., RRC 621)). The eNB 103 also includes the following functions: Inter Cell RRM (Radio Resource Management) 623, Connection Mobility Control 625, RB (Radio Bearer) Control 627, Radio Admission Control 629, eNB Measurement Configuration and Provision 631, and Dynamic Resource Allocation (Scheduler) 633.

The eNB 103 communicates with the aGW 601 (Access Gateway) via an S1 interface. The aGW 601 includes a User Plane 601a and a Control plane 601b. The control plane 601b provides the following components: SAE (System Architecture Evolution) Bearer Control 635 and MM (Mobile Management) Entity 637. The user plane 601b includes a PDCP (Packet Data Convergence Protocol) 639 and a user plane functions 641. It is noted that the functionality of the aGW 601 can also be provided by a combination of a serving gateway (SGW) and a packet data network (PDN) GW. The aGW 601 can also interface with a packet network, such as the Internet 643.

In an alternative embodiment, as shown in FIG. 6D, the PDCP (Packet Data Convergence Protocol) functionality can reside in the eNB 103 rather than the GW 601. Other than this PDCP capability, the eNB functions of FIG. 6C are also provided in this architecture.

In the system of FIG. 6D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 86.300.

The eNB 103 interfaces via the S1 to the Serving Gateway 645, which includes a Mobility Anchoring function 647. According to this architecture, the MME (Mobility Management Entity) 649 provides SAE (System Architecture Evolution) Bearer Control 651, Idle State Mobility Handling 653, and NAS (Non-Access Stratum) Security 655.

One of ordinary skill in the art would recognize that the processes for scheduling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

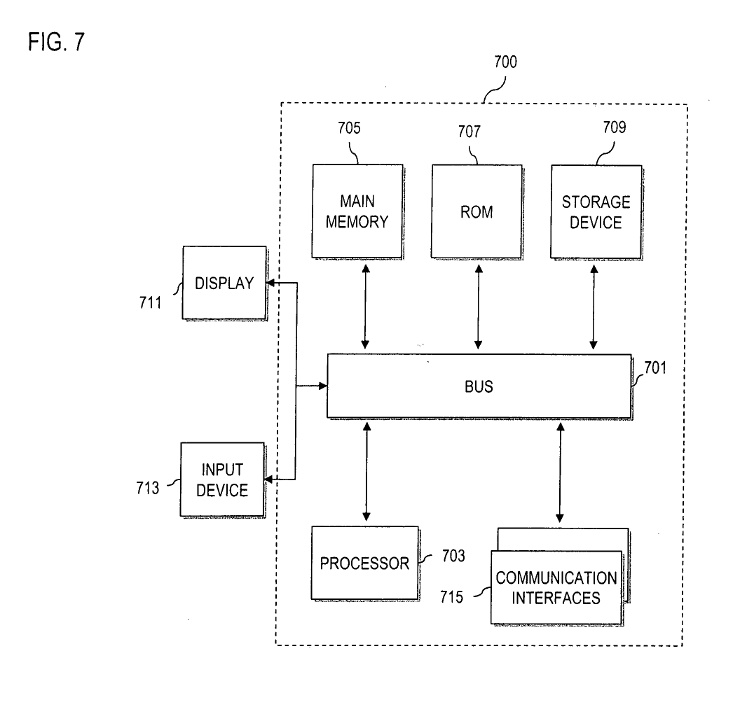

FIG. 7 illustrates exemplary hardware upon which various embodiments of the invention can be implemented. A computing system 700 includes a bus 701 or other communication mechanism for communicating information and a processor 703 coupled to the bus 701 for processing information. The computing system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computing system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computing system 700 may be coupled via the bus 701 to a display 711, such as a liquid crystal display, or active matrix display, for displaying information to a user. An input device 713, such as a keyboard including alphanumeric and other keys, may be coupled to the bus 701 for communicating information and command selections to the processor 703. The input device 713 can include a cursor control, such as a mouse, a trackball, or cursor direction keys, for communicating direction information and command selections to the processor 703 and for controlling cursor movement on the display 711.

According to various embodiments of the invention, the processes described herein can be provided by the computing system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 700 also includes at least one communication interface 715 coupled to bus 701. The communication interface 715 provides a two-way data communication coupling to a network link (not shown). The communication interface 715 sends and receives electrical, electromagnetic, or optical signals that carry digital data streams representing various types of information. Further, the communication interface 715 can include peripheral interface devices, such as a Universal Serial Bus (USB) interface, a PCMCIA (Personal Computer Memory Card International Association) interface, etc.

The processor 703 may execute the transmitted code while being received and/or store the code in the storage device 709, or other non-volatile storage for later execution. In this manner, the computing system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

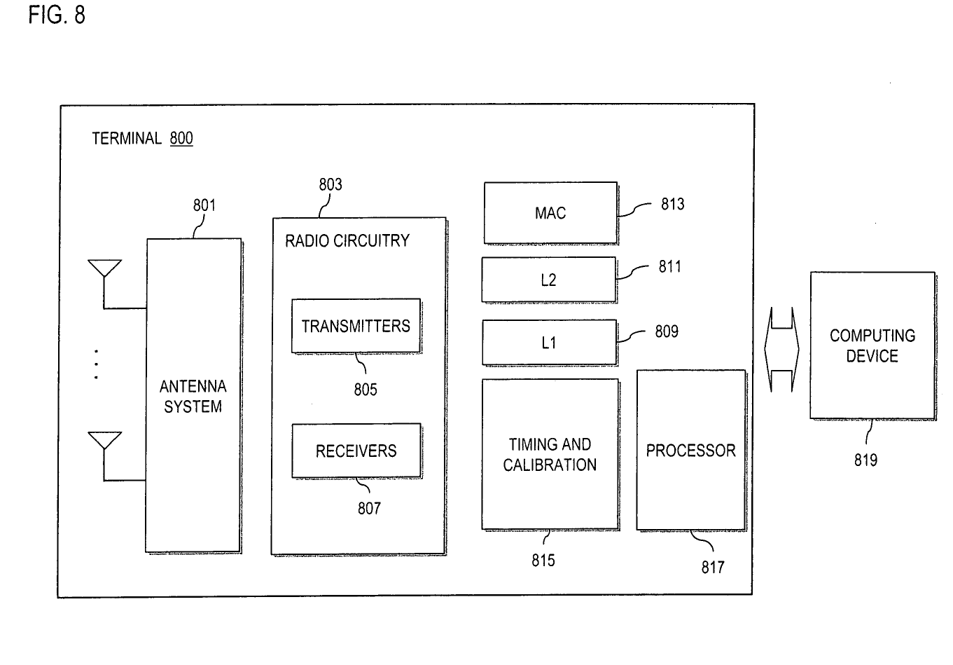

FIG. 8 is a diagram of exemplary components of a user terminal configured to operate in the systems of FIGS. 5 and 6, according to an embodiment of the invention. A user terminal 800 includes an antenna system 801 (which can utilize multiple antennas) to receive and transmit signals. The antenna system 801 is coupled to radio circuitry 803, which includes multiple transmitters 805 and receivers 807. The radio circuitry encompasses all of the Radio Frequency (RF) circuitry as well as base-band processing circuitry. As shown, layer-1 (L1) and layer-2 (L2) processing are provided by units 809 and 811, respectively. Optionally, layer-3 functions can be provided (not shown). Module 813 executes all Medium Access Control (MAC) layer functions. A timing and calibration module 815 maintains proper timing by interfacing, for example, an external timing reference (not shown). Additionally, a processor 817 is included. Under this scenario, the user terminal 800 communicates with a computing device 819, which can be a personal computer, work station, a Personal Digital Assistant (PDA), web appliance, cellular phone, etc.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-25. (canceled)

26. A method comprising:
generating a multicast request message specifying bandwidth requests and slot availability information to one or more neighboring nodes in a multicast group of a meshed wireless network, wherein the multicast group has a multicast identifier;
receiving a first grant message, in response to the request message, specifying a set of slots corresponding to the slot availability information;
tracking responses from the neighboring nodes designated as requestee nodes;
sending a second grant message to indicate a final multicast schedule to the neighboring nodes;
receiving a third grant message from the neighboring nodes confirming the final multicast schedule, wherein the third grant message is further provided to neighboring nodes of the requestee nodes; and
transmitting data irrespective of whether the third grant message is received.

27. A method according to claim 26, further comprising:
releasing the multicast link identifiers or keeping the multicast link identifiers for future use after the transmission of the data.

28. A method according to claim 26, wherein the multicast group is a medium access control layer multicast group.

29. An apparatus comprising:
at least one processor
and at least one memory including computer program code,
the at least one memory and the computer program code configured to, with the at least one processor, cause the apparatus at least to
generate a multicast request message specifying bandwidth requests and slot availability information to one or more neighboring codes in a multicast group of a meshed wireless network, wherein the multicast group has a multicast identifier;
receive a first grant message, in response to the request message, specifying a set of slots corresponding to the slot availability information;
track responses from the neighboring nodes designated as requestee nodes;
send a second grant message to indicate a final multicast schedule to the neighboring nodes;
receive a third grant message from the neighboring nodes confirming the final multicast schedule, wherein the third grant message is further provided to neighboring nodes of the requestee nodes; and
transmit data irrespective of whether the third grant message is received.

30. An apparatus according to claim 29, wherein the at least one memory and the computer program code further configured to, with the at least one processor, cause the apparatus to release the multicast link identifiers or keep the multicast link identifiers for future use after the transmission of the data.

31. An apparatus according to claim 29, wherein the multicast group is a medium access control layer multicast group.

32. A method comprising:
receiving a multicast scheduling request from a requester node over a meshed wireless network, wherein a multicast group comprises neighboring nodes of the requester;
sending a grant to the requester in response to the request to indicate a selection of transmission opportunities;
receiving a multicast schedule from the requestor, wherein the multicast schedule specifies one or more of the transmission opportunities;
confirming the multicast schedule; and
sending a second grant to the requester in response to the multicast schedule confirming the multicast schedule and informing neighboring nodes.

33. A method according to claim 32, wherein communication with the multicast group involves assignment of a plurality of multicast link identifiers.

34. An apparatus comprising:
at least one processor
and at least one memory including computer program code,
the at least one memory and the computer program code configured to, with the at least one processor, cause the apparatus at least to
receive a multicast scheduling request from a requester node over a meshed wireless network, wherein a multicast group comprises neighboring nodes of the requester;
send a grant to the requester in response to the request to indicate a selection of transmission opportunities;
receive a multicast schedule from the requestor, wherein the multicast schedule specifies one or more of the transmission opportunities;
confirm the multicast schedule; and
send a second grant to the requester in response to the multicast schedule confirming the multicast schedule and informing neighboring nodes.

35. An apparatus according to claim 34, wherein communication with the multicast group involves assignment of a plurality of multicast link identifiers.
